(19) United States
(12) Patent Application Publication
(10) Pub. No.: US 2014/0013976 A1
(43) Pub. Date: Jan. 16, 2014

(54) METAL-BACKED PRINTING BLANKET

(71) Applicant: ContiTech Elastomer-Beschichtungen GmbH, Hannover (DE)

(72) Inventors: Stefan Fuellgraf, Duderstadt (DE); Detlef Roeder, Kaltenburg-Lindau (DE)

(73) Assignee: ContiTech Elastomer-Beschichtungen GmbH, Hannover (DE)

(21) Appl. No.: 14/027,679

(22) Filed: Sep. 16, 2013

Related U.S. Application Data
(63) Continuation of application No. PCT/EP2012/051015, filed on Jan. 24, 2012.

(30) Foreign Application Priority Data
Mar. 16, 2011 (DE) 10 2011 001 316.4

(51) Int. Cl. B41N 10/02

(52) U.S. Cl. CPC B41N 10/02
USPC 101/401.1

(57) ABSTRACT

A metal-backed printing blanket includes the following layers: a printing layer, a metal foil and a cover layer bonded to the surface of the metal foil that faces away from the printing layer. The cover layer is irreversibly bonded to the metal foil by a chemically-curing adhesive.

### CROSS REFERENCE TO RELATED APPLICATIONS

This application is a continuation application of international patent application PCT/EP2012/051015, filed Jan. 24, 2012, designating the United States and claiming priority from German application 10 2011 001 316.4, filed Mar. 16, 2011, and the entire content of both applications is incorporated herein by reference.

### FIELD OF THE INVENTION

The invention relates to a metal-backed printing blanket which includes a printing layer, a metal foil, and a cover layer bonded to the surface of the metal foil which faces away from the printing layer.

### BACKGROUND OF THE INVENTION

One printing blanket of this kind is known from United States patent application publication 2010/0236434 A1, for example. In the case of the printing blanket known from that publication, the cover layer takes the form of a plastic foil bonded to the metal foil via a hotmelt adhesive. Using a hotmelt adhesive allows the adhesive bond between the metal foil and the plastic foil to be made easily. It is found, however, that in a printing machine the printing blanket may be subject to locally severe heating. This may become a situation where the hotmelt adhesive melts between the metal foil and the plastic foil, and the plastic foil undergoes regional detachment from the metal foil. Detachment of the plastic foil from the metal foil can lead to an unwanted fluctuation in thickness in the printing blanket, and hence to an impaired print outcome.

### SUMMARY OF THE INVENTION

It is an object of the invention to provide a printing blanket which securely withstands the ambient influences acting on the printing blanket during a printing operation.

The object is achieved by the cover layer being irreversibly bonded to the metal foil via a chemically curing adhesive.

Irreversible bonding in the sense of the invention means a bond which withstands thermal loads at temperatures of up to at least 80° C. and withstands the detergents used in the printing industry with the customary solvents, especially hydrocarbon-containing solvents.

The advantage achieved with the invention is seen as being the ability, using a chemically curing (setting) adhesive, to produce a firm, irreversible bond between the metal foil and cover layer. Another perceived advantage of the invention is that this bond withstands the ambient influences to which a printing blanket is exposed during the printing operation.

Any chemically curing adhesive can be used with which an irreversible bond in the above sense can be made, examples being polyurethane adhesives or radiation-curing adhesives (not only adhesives which are cured by UV radiation but also adhesives which are cured by other radiation sources, such as electron beam sources, for example). In accordance with a feature of the invention, however, the plastic foil is bonded to the metal foil preferably via an epoxy resin adhesive. The advantage of this development is that an epoxy adhesive, after curing, can be separated only by mechanical exposure. A printing blanket in accordance with the development therefore withstands the ambient influences during the printing operation particularly well, since the mechanical forces that occur during a printing operation are unable to result in a breakdown of the adhesive bond.

According to another feature of the invention, the epoxy resin adhesive is in two-component form. The epoxy resin adhesive is constructed more particularly from an epoxy resin and a hardener, the polymer building blocks used as epoxy resin being blocks which carry so-called epoxide groups at the end. For this purpose it is possible, for example, to use the reaction products of bisphenol A and epichlorohydrin, which, after mixing with the hardener, which contains amino groups or mercapto groups, form a stable thermoset. The advantage of the development is that the curing reaction in the case of a two-component epoxy resin adhesive can be performed at room temperatures. It is likewise possible to perform the curing reaction at temperatures higher than room temperature, as result of which a higher bond strength can be obtained.

According to another feature of the invention, the epoxy resin adhesive is in single-component form. A single-component epoxy resin adhesive for the purposes of the invention is an epoxy resin adhesive where resin component and hardener component have been mixed with one another in the correct proportion even before the printing blanket is produced. Single-component epoxy resin adhesives are discernible from the fact that hardeners are used which react only very slowly at room temperatures (for example, dicyandiamide), and so the adhesive must be cured under hot conditions. The advantage of the development is that mixing of the adhesive components during the production of the printing blanket can be avoided.

According to still another feature of the invention, the cover layer is a plastic foil: This foil preferably is made of PET or of PVC. The advantage of this feature is that a plastic foil can easily be produced with a uniform thickness, and so, in the printing blanket, there are no fluctuations in thickness arising from different thicknesses on the part of the plastic foil. A further advantage of this feature is that a plastic foil can be bonded particularly well with a chemically curing adhesive, more particularly an epoxy resin adhesive.

According to another feature of the invention, the cover layer is a nonwoven fabric. An advantage of this embodiment is that a nonwoven fabric is able to absorb the moisture which may come between the printing blanket and the printing roll when the printing blanket is washed off with a detergent. On rotation of the printing roll, the moisture is able to distribute itself uniformly in the nonwoven fabric, and so there is no local thickening of the printing blanket.

The nonwoven fabric may take the form of paper, for example. According to a further embodiment of the invention, however, the nonwoven fabric preferably takes the form of a plastic nonwoven fabric. An advantage of this feature is that a plastic nonwoven fabric does not swell on absorption of moisture, and so there is no thickening of the printing blanket arising from the moisture absorbed by the nonwoven fabric.

### BRIEF DESCRIPTION OF THE DRAWING

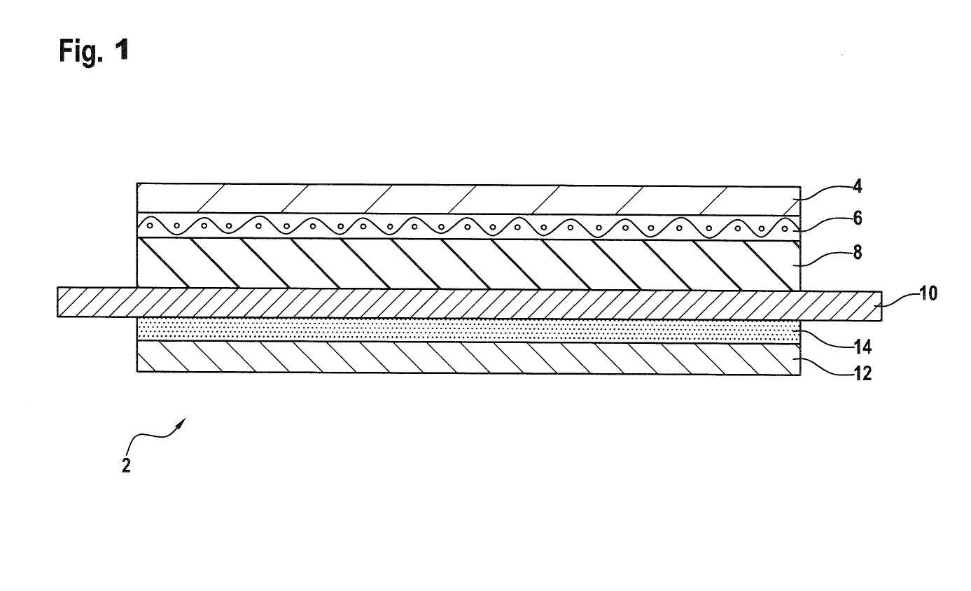

The invention will now be described with reference to the single FIGURE of the drawing (FIG. 1) which shows a metal-backed printing blanket according to the invention.

### DESCRIPTION OF THE PREFERRED EMBODIMENTS OF THE INVENTION

FIG. 1 shows a metal-backed printing blanket 2 having a printing layer 4, a fabric layer 6, a compressible layer 8, a metal foil 10, and a cover layer 12, which is disposed on the surface of the metal foil 10 remote from the printing layer 4. At each of the edges, metal foil 10 protrudes beyond the other layers of the printing blanket 2, forming free metal-foil ends which can be used to clamp the printing blanket 2 into the nip of a printing cylinder, not shown. The printing blanket may, in addition to the fabric layer, include further or alternative layers.

The cover layer 12 is bonded irreversibly and over its entire area to the metal foil 10 via an adhesive layer 14 comprising a chemically curing adhesive. The chemically curing adhesive is selected such that the adhesive layer 14 withstands the thermal loads of at least 80° C. and withstands the detergents used in the printing industry with the customary solvents, especially hydrocarbon-containing solvents. The chemically curing adhesive in the adhesive layer 14 takes the preferred form of an epoxy resin adhesive, which may be either a two-component or a single-component adhesive. The cover layer 12 is a plastic foil or a nonwoven fabric, more particularly a plastic non-woven fabric.

It is understood that the foregoing description is that of the preferred embodiments of the invention and that various changes and modifications may be made thereto without departing from the spirit and scope of the invention as defined in the appended claims.

### LIST OF REFERENCE NUMERALS

### Part of the Description

2 metal-backed printing blanket
4 printing layer
6 fabric ply
8 compressible layer
10 metal foil
12 cover layer
14 adhesive layer

What is claimed is:

1. A metal-backed printing blanket comprising:
a printing layer;
a metal foil having a first surface facing away from said printing layer; and,
a cover layer irreversibly bonded to said first surface of said metal foil via a chemically curing adhesive.

2. The metal-backed printing blanket of claim 1, wherein said cover layer is bonded to said metal foil via an epoxy resin adhesive.

3. The metal-backed printing blanket of claim 2, wherein said epoxy resin adhesive is a two-component adhesive.

4. The metal-backed printing blanket of claim 2, wherein said epoxy resin adhesive is a single-component adhesive.

5. The metal-backed printing blanket of claim 1, wherein said cover layer is a plastic foil.

6. The metal-backed printing blanket of claim 1, wherein said cover layer is a non-woven fabric.

7. The metal-backed printing blanket of claim 6, wherein said non-woven fabric is a plastic non-woven fabric.

8. A metal-backed printing blanket comprising:
a printing layer;
a metal foil having a first surface facing away from said printing layer;
a cover layer;
an adhesive layer interposed between said metal foil and said cover layer; and,
said adhesive layer being made up of a chemically curing adhesive for irreversibly bonding said cover layer to said first surface of said metal foil.
